(19) United States
(12) Patent Application Publication
(10) Pub. No.: US 2008/0138756 A1
(43) Pub. Date: Jun. 12, 2008

(54) Orthondontic Bracket With Mesial And Distal Tie Wing Undercuts

(75) Inventors: Hong Meng Lim, Singapore (SG); Kok Liang Tan, Singapore (SG)

Correspondence Address: Law Offices of Albert Wai-Kit Chan, World Plaza, Suite 604, 141-07 20th Avenue, Whitestone, NY, 11357, US

(73) Assignee: INNOBRACE ORTHODONTICS PTE LTD, Singapore (SG)

(21) Appl. No.: 11/547,551

(22) PCT Filed: Apr. 1, 2005
(86) PCT No.: PCT/SG2005/000107

§ 371 Date: Sep. 29, 2006

Related U.S. Application Data
(60) Provisional application No. 60/558,413, filed on Apr. 1, 2004.

(51) Int. Cl. A61C 7/12

(52) U.S. Cl. 433/10

(57) ABSTRACT

The present invention relates to an improvement to an orthodontic appliance comprising of a bracket (10), which further includes a base portion (12), a body section (24) extending from the base portion (12), and wherein said improved orthodontic appliance comprises of a plurality of edges (14, 16, 18, 20) and a set of tie wings (22a, 22b), and wherein said orthodontic appliance also includes an archwire slot (26) and a vertical slot (27) and wherein a plurality of channels (36) is provided therein on the bottom surface of the orthodontic appliance and wherein a mesial tie wing undercut (32) and a distal tie wing undercut (34) are provided respectively to form a continuous undercut channels with an incisal and a gingival tie wing undercuts (40, 38).

### FIELD OF THE INVENTION

The present invention relates to an orthodontic appliance. More particularly the present invention relates to an improvement to a configuration of an orthodontic appliance with an integrated built body and base design to maximize the advantages of the injection molding manufacturing process.

### BACKGROUND OF THE INVENTION

Orthodontic is a branch of dentistry, which involves the re-arrangement of crooked teeth and to move them into an aesthetic, functional and harmonious position in relation to the rest of the face.

It is known to a person skilled in the present art that bonded orthodontic appliance typically consist of a plurality of orthodontic brackets and tubes, archwires and ligature wires or rings. An orthodontic bracket typically comprises of a body portion and a base portion. The body portion further comprises of archwire slot for receiving an arch wire and a plurality of tie wings projecting outwardly for attaching ligature wires or elastomeric rings to secure the archwire to the bracket. The base portion further comprises of a tooth-abutting surface shaped generally to conform to the morphology of a tooth.

Currently, the twin edgewise brackets are the most widely used bracket design. This is mainly because of its ability to allow better rotational and angulation control when said brackets are in use. However, the increased width of the twin edgewise brackets have resulted in a decrease in the inter-bracket distance. This has further resulted in a decrease in the flexibility of the arch wire used thereto especially at the initial stage of the treatment. This has also known to increase the force applied onto the tooth during the treatment, which may be painful to a patient.

Most edgewise slots have a right-angled or angular mesial and distal slot corners. Especially for ceramic brackets, this feature leads to the binding of the metallic arch wires against the corners during the initial stages of the treatment when slot line up has not been achieved.

It is also known that rounding the mesial and distal slot corners will increase the effective inter-bracket distance as well as reduce the binding effect of the archwires against the corners during treatment. However, rounding the mesial and distal slot corners can result in a reduction in the effectiveness of angulation control.

It is known to a person skilled in the art that ceramic brackets can be bonded to the tooth surface by either chemical or mechanical means or a combination of both. The base designs for chemically retained ceramic brackets are simpler and depends on the application of the chemical agent such as silane to achieve the chemical retention required therein. The base design for a mechanically retained ceramic bracket is more complicated. Various methods of incorporating retentive features on the bracket base have been used hereto.

However, most of these methods require some form of secondary process after the ceramic bracket is created in order to modify the base to that of a chemically or mechanically retained base. It is also known that most of the secondary processes are elaborate and adds significantly to the cost of manufacturing and time spent therein. Some of the said bases may even become detached during the course of treatment.

Now, some examples of orthodontic appliances in the prior art as mentioned above would be described briefly.

U.S. Pat. No. 5,238,403 teaches an improved orthodontic appliance of the twin bracket edgewise type in which a pair of spaced apart brackets are affixed to a pad member adapted for attachment to the surface of a tooth, each of the brackets including a base portion resting against the pad member, upper and lower wing portions projecting outwardly from the base portion and an outwardly opening slot of predetermined height between the upper and lower wing portions for receiving an arch wire in cooperation therewith, the height of the arch wire receiving slot of one of the brackets being greater than the arch wire receiving slot of the other.

U.S. Pat. No. 5,067,897 teaches a twin tie wing orthodontic bracket having a pair of substantially parallel spaced tie wings extending from a base portion adapted to be attached to a tooth, and a horizontally opening buccolabially extending arch wire slot and cut outs at the mesial and distal sides of the bracket at the arch wire slot and the buccolabial face which increases the interbracket distance and thereby increases the range of the arch wire and decreases the force the arch wire exerts on the brackets.

U.S. Pat. No. 4,531,911 teaches a combination single/twin edgewise orthodontic bracket incorporating twin tie wings to promote twin ligating capability and over-rotation capability, and also incorporating an intermediate section of single bracket width that defines a precision arch wire slot for receiving an edgewise arch wire of rectangular cross sectional configuration to promote orthodontic treatment with the edgewise orthodontic technique. Relief grooves between the upper and lower tie wings extend outwardly from the ends of the precision arch wire slot and are relieved in both width and depth as they traverse each tie wing mesially and distally to provide for efficient over-rotation control. The relief grooves cooperate with the central bracket section to permit the fullest expression of the advantages of interbracket width. The single/twin tying, bracket features may be employed in a wide variety of bracket structures including “T” brackets, which accommodate loops more conveniently while preserving the advantages promoted by spaced ligating tie wings. Transverse ligature slots formed in the proximal edges or ends of the bracket permit application of efficient force vectors to the edgewise arch wire even when the arch wire slot is severely angulated to maintain optimum seating of the arch wire within its slot.

U.S. Pat. No. 4,673,354 teaches a method for priming a dental material using a liquid layer of acidic, non-hazy silanol priming solution containing substantially fully hydrolysed organo functional silanol, water, and volatile alcohol or ketone solvent. The compositions contain a sufficiently low amount of silanol and sufficiently high amounts of solvent and acid to have a priming strength in excess of the cohesive strength of dental porcelain after storage of the solution at room temperature for at least about 45 days.

U.S. Pat. No. 5,269,680 teaches a method of bonding ceramic brackets to teeth using silane coupling where the bond strength can be controlled by applying a layer of organic paint. The method as described comprises the application of a silane coupling agent to the base surface of a bracket and the application of an organic paint to the entire or a portion of the silane coupling agent such that when an organic adhesive is applied to the base surface of the bracket, the organic paint would partially shield the silane coupling and thereby lowering the bond strength. The organic paint can be applied in different configurations to the silane-coupling agent on the base surface of the bracket in such that the bond strength is decreased only over selected areas of the base surface.

U.S. Pat. No. 5,256,062 teaches a dental bracket which comprises of a non-metallic bracket, typically formed from a transparent crystalline alumina. To this non-metallic bracket there is bound a stainless steel metallic foil mesh base pad which is adhesively connected to the dental bracket body. The foil mesh pad can thereafter be bound to the tooth using typical adhesives, and without worrying of bonding or debonding associated with ceramic or crystalline brackets. This patent also teaches that if desired one can make the stainless steel pad aesthetically pleasing, to obtain further aesthetic benefits from this device.

U.S. Pat. No. 5,098,288 teaches the attachment of a polycarbonate mesh base to the ceramic bracket body. Failure at the polycarbonate mesh and bracket body is known to occur during treatment.

U.S. Pat. No. 5,108,285 teaches a base and a method of making a base for a ceramic orthodontic bracket to provide mechanical retention between the bracket and the tooth so that the bracket may be debonded by the failure of the mechanical bond at the bracket/bond interface when the shear strength of the bond is exceeded. The bracket-bonding base includes a glass frit fired to the tooth attaching side of the bracket and layer of textured aluminium oxide fired to the frit. The method of making the bonding base includes controlled preparation of a glass ceramic glaze (frit) to have a coefficient of thermal expansion slightly less then that of the bracket and application of the glaze to the bracket base. Thereafter, a proper firing sequence transforms the glaze into a sintered glass ceramic. A specially prepared textured substance is then applied to the sintered ceramic glaze and the bracket is again fired under controlled conditions in order to fuse the textured substance with the glaze.

U.S. Pat. No. 5,439,379 teaches an orthodontic bracket that is debonded from a tooth by pivoting its mesial and distal sections toward each other in respective arcs about a central reference axis extending in an occlusal-gingival direction. The mesial and distal sections are discrete and spaced apart from each other, or alternatively integrally joined by a relatively thin web that bends and optionally fractures upon debonding. A metallic arch wire slot liner interconnects the mesial and distal sections and enhances sliding mechanics of the bracket. A pliers-like debonding tool includes jaws with stops for limiting the lingual depth of engagement of the jaws with the mesial and distal sides of the bracket, to facilitate pivoting of the mesial and distal sections during debonding. However, the disadvantage of such configuration is that the thin web between the mesial and distal section does not break reliably when required, and it is also known to break prematurely during treatment.

U.S. Pat. Nos. 5,066,225 and 5,109,586 teach a method of manufacturing an orthodontic bracket from crystalline alumina, preferably crystalline alpha-alumina. The bracket comprises a base member for attaching to a tooth and a body member extending from the base member. The body member includes walls that define an arch wire groove. The walls comprise crystalline alumina. The bracket has sufficient strength to withstand normal torquing forces imparted by an arch wire.

This method employs the extrusion technique of production and this followed by griding or milling of the product to achieve the final form of the orthodontic brackets. However, the extrusion method and griding/milling usually results in sharp edges and corners as well as stress concentration within the bracket body and base.

Therefore, as mentioned earlier, most of the above mentioned methods require some form of secondary process after the ceramic bracket is created to modify the base to that of a mechanically retained base. It is also known that most of the secondary processes are elaborate and adds significantly to the cost of manufacturing and time spent therein. Some of the said bases may even become detached during the course of treatment.

Any discussion of documents, devices, acts or knowledge in this specification is included to explain the context of the invention. It should not be taken as an admission that any of the material forms a part of the prior art base or the common general knowledge in the relevant art in Singapore or elsewhere on or before the priority date of the disclosure and claims herein. All statements as to the date or representation as to the contents of these documents is based on the information available to the applicant and does not constitute any admission as to the correctness of the dates or contents of these documents.

In light of the above, it is an objective of the present invention to overcome or reduce the above mentioned disadvantages by introducing an improved orthodontic appliance in which said improved orthodontic appliance is capable of eliminating elaborate labour intensive, time consuming and costly secondary processes in order to achieve a mechanical bonding base. It is yet another objective of the present invention to allow the use of standard bonding materials for the mechanical bonding base and thus eliminating the use of chemical bonding and thereafter avoiding the hazard of debonding chemical bonded material.

It is also the objective of the present invention to introduce and combine both the curved or rounded mesial and distal edges of the archwire slot with the new feature of mesial and distal tie wing undercuts. This is to overcome the loss of effectiveness of angulation control as a result of the increase in effective inter-bracket distance from the curved or rounded mesial and distal edges of the archwire slot.

### SUMMARY OF THE INVENTION

The present invention relates to an improvement to an orthodontic appliance comprising of a bracket, which further includes a base portion, a body section extending from the base portion. Said improved orthodontic appliance comprises of a plurality of edges and a set of tie wings. Said orthodontic appliance also includes an archwire slot and a vertical slot and wherein a plurality of channels is provided therein on the bottom surface of the orthodontic appliance and wherein a mesial tie wing undercut and a distal tie wing undercut are provided respectively to form a continuous undercut channels with an incisal and a gingival tie wing undercuts.

The plurality of edges as mentioned earlier is a mesial edge, a distal edge, a gingival edge and an incisal edge. Said edges are integrally mounted to the body section. The tie wings are twin tie wings and are integrally mounted to the base portion in a manner that it extends outwardly away from the base portion. Each of the said tie wings is positioned parallel and spaced apart from one another.

The archwire slot is provided at the body section and wherein said archwire slot is generally extended from one tie wing and projects to the other tie wing. According to the present invention the archwire slot is positioned perpendicular to the mesial and distal edges. Said archwire slot further includes a mesial end and a distal end.

The vertical slot according to the current invention is provided at the body section and is positioned extending perpendicular to the archwire slot. The vertical slot is a closed channel and is partly hidden in the body section.

Each of the tie wings further includes a mesial tie wing undercut and a distal tie wing undercut respectively. The gingival edge and the incisal edge further include a gingival tie wing undercut and an incisal tie wing undercut respectively, and wherein all the undercuts are designed with deep cutting portions and are generally concave in configuration.

The mesial tie wing undercut is provided to connect the mesial edge to the gingival edge to create a continuous joint whilst the distal tie wing undercut is provided to connect the distal edge and the incisal edge to create another continuous joint.

According to the present invention the edges of the mesial and distal are either rounded or curved. Also, according to the present invention wherein the archwire slot is provided with rounded or curved mesial and distal corners.

The earlier mentioned channels are designed to have a tapered portion at the end approximate to a tooth surface thus creating a required undercut for mechanical bonding. According to the present invention, said orthodontic appliance is manufactured to completion as a single integral piece, in a single injection molding process.

Other aspects and preferred aspects are disclosed in the specification and/or defined in the appended claims, forming a part of the description of the invention.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

Further disclosure, objects, advantages and aspects of the present application may be better understood by those skilled in the relevant art by reference to the following description of preferred embodiments taken in conjunction with the accompanying drawings, which are given by way of illustration only, and thus are not limitative of the present invention, and in which:

FIG. 1 shows a plan view of an improved orthodontic bracket;

FIG. 2 shows a bottom view of the orthodontic bracket as shown in FIG. 1;

FIG. 3 shows a perspective view of the orthodontic bracket as shown in FIG. 1;

FIG. 4 shows a side view of the orthodontic bracket as shown in FIG. 1;

FIG. 5 shows another perspective view of the orthodontic bracket as shown in FIG. 3; and

FIG. 6 shows another side view of the orthodontic bracket as shown in FIG. 4.

### DETAILED DESCRIPTION OF THE INVENTION

The present invention will be described in relation to the accompanying drawings, which would assist in illustrating various features of the present invention. It should be understood that the terms used to describe the bracket herein would be in reference to the positioning of the structure when the said bracket is installed on the tooth of an orthodontic patient. It should also be appreciated that the principles of the present invention discussed herein may be applicable to a variety of types of edgewise brackets for the upper and lower jaws, including brackets made of different materials and with varying degrees of torque and/or angulation.

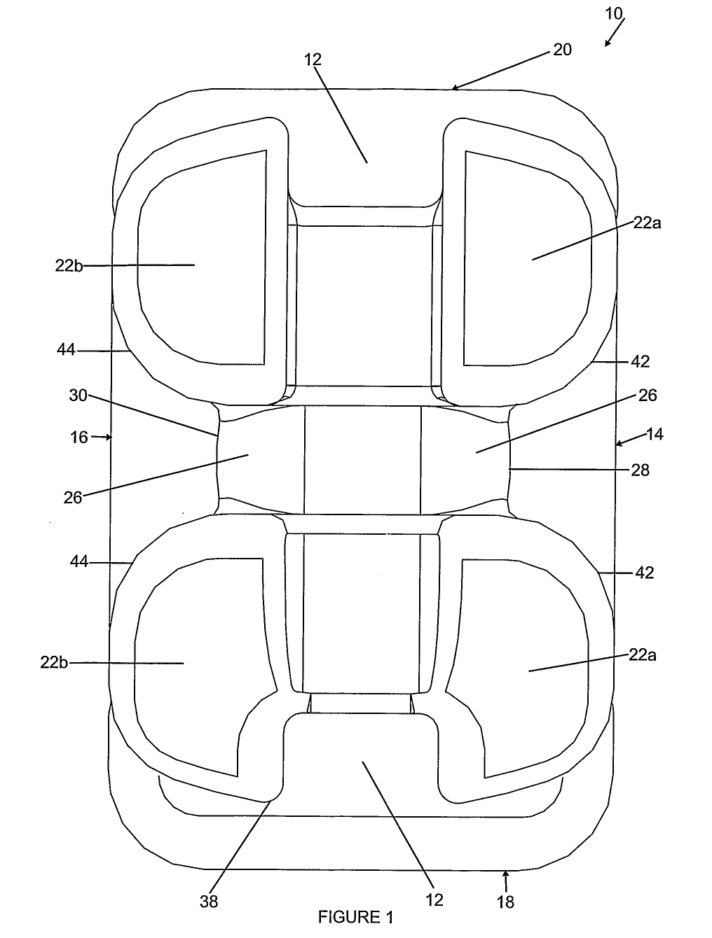

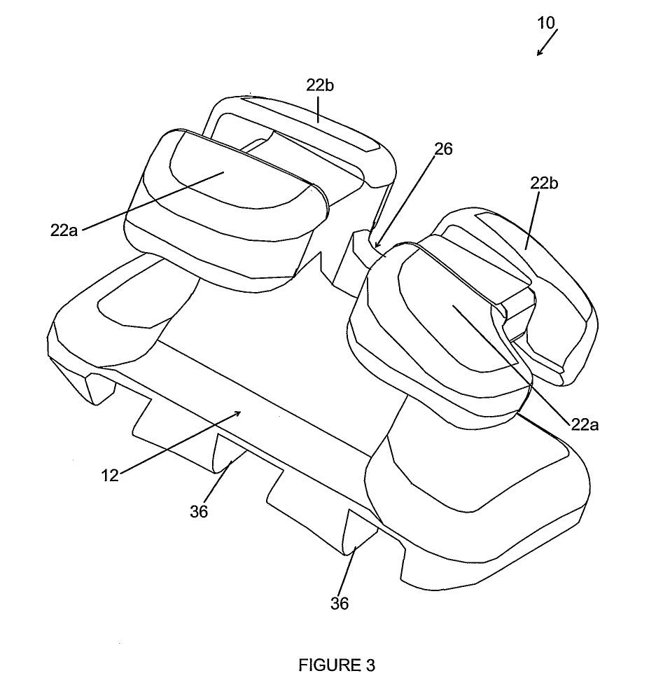

The present invention, hereinafter, referred as a bracket (10) is best illustrated in FIG. 3. The bracket (10) comprises of a base portion (12) as shown in FIGS. 1 to 4. In order to facilitate ease of describing the present invention, some assumptions are made herein. It is assumed that the bracket (10) as shown in FIGS. 1 to 4 is a lower right central incisor bracket. The term lower right central incisor bracket is a standard term used by orthodontics and therefore no further definition is required. Based on the assumption as mentioned earlier, generally said bracket (10) further includes a mesial edge (14), a distal edge (16), a gingival edge (18) and an incisal edge (20). Further to this, said twin tie wings (22a, 22b) are provided to a body section (24) of the base portion (12). Said twin tie wings (22a, 22b) are configured and designed in such a manner that they are extended outwardly away from the base portion (12) of the bracket (10). Each of the said tie wings (22a, 22b) are positioned parallel and spaced apart form one another.

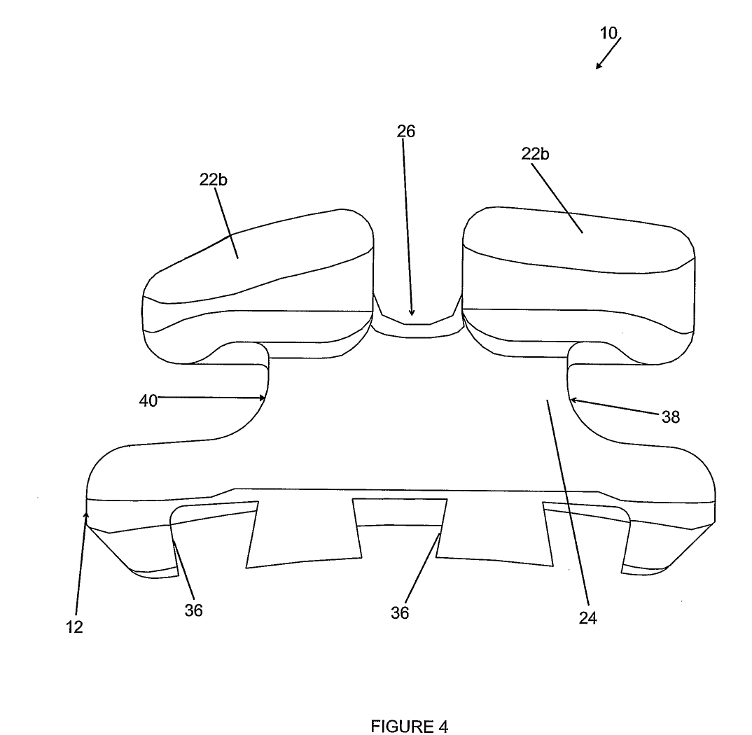

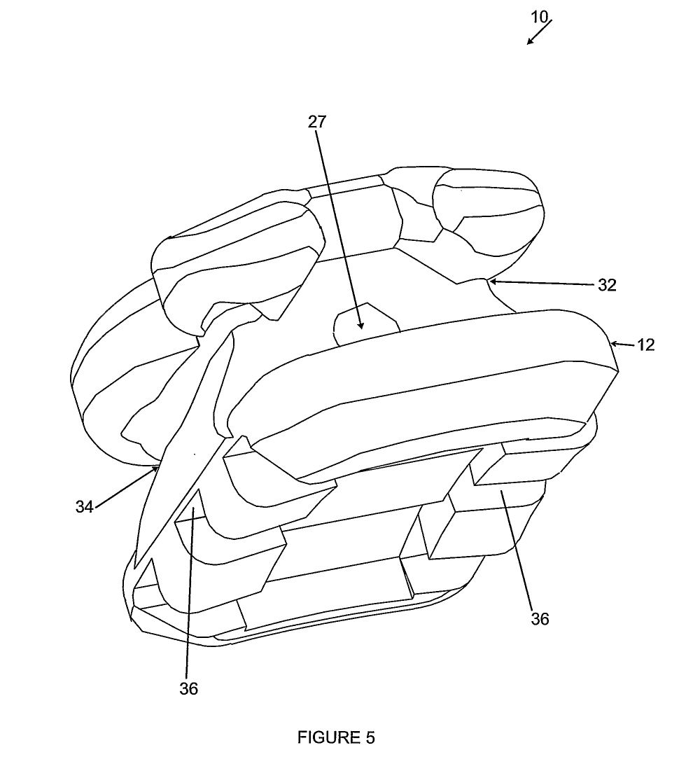

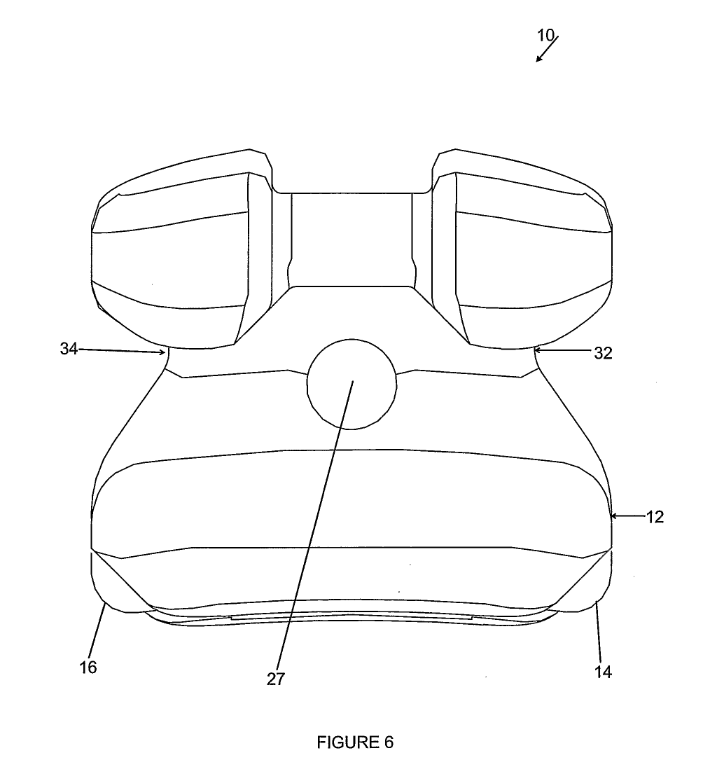

An archwire slot (26) is provided at the body section (24) of the present invention in such that said archwire slot (26) generally is extended from the tie wing (22a) and projects to the tie wing (22b) as shown in FIG. 4. In order to further clarify, the manner said archwire slot (26) is positioned, reference is made to FIGS. 1 and 3 wherein said archwire slot (26) is extended perpendicular to the arrangement of each mesial edge (14) and distal edge (16) on each tie wing (22a, 22b). Further to this, said archwire slot (26) could be defined having a mesial end (28) and a distal end (30). It would be understood that the mesial end (28) is located at the mesial edge (14) while the distal end (30) is located at the distal edge (16). A vertical slot (27) is also provided at the body section (24) as shown in FIGS. 5 and 6. Said vertical slot (27) is designed and configured to extend perpendicularly to the archwire slot (26). It should also be appreciated that the said vertical slot (27) is a closed channel and is not entirely visible to the naked eye as it is held within the body section (24). The portions of the said vertical slot (27), which are visible, would be the middle, incisal and gingival ends. Said vertical slot (27) is generally a tubular shape like member in cross section (not illustrated) and having its curvature perimeter sidewall.

Each of the said tie wings (22a, 22b) is further provided with a mesial tie wing undercut (32) and a distal tie wing undercut (34) respectively, as shown in FIG. 5. The mesial tie wing undercut (32) and the distal tie wing undercut (34) connect to a gingival tie wing undercut (38) and an incisal tie wing undercut (40) and thereafter creating a continuous channel of tie wing undercuts. Said mesial, distal, gingival and incisal tie wing undercuts (32, 34, 38, 40) are designed to have a deep cutting portion and are generally in a concave configuration. The configuration of said mesial tie wing undercut (32) is such that it is generally connects the mesial edge (14) to the gingival edge (18) and thereafter creating a continuous joint. Similar arrangement is provided between the distal edge (16) and the incisal edge (20) wherein the distal tie wing undercut (34) is provided therein to create another continuous joint. It should not be confused that each of the above mentioned features are joint together to form a single structure. Instead, the said features are integrally connected to one another to form a single structure.

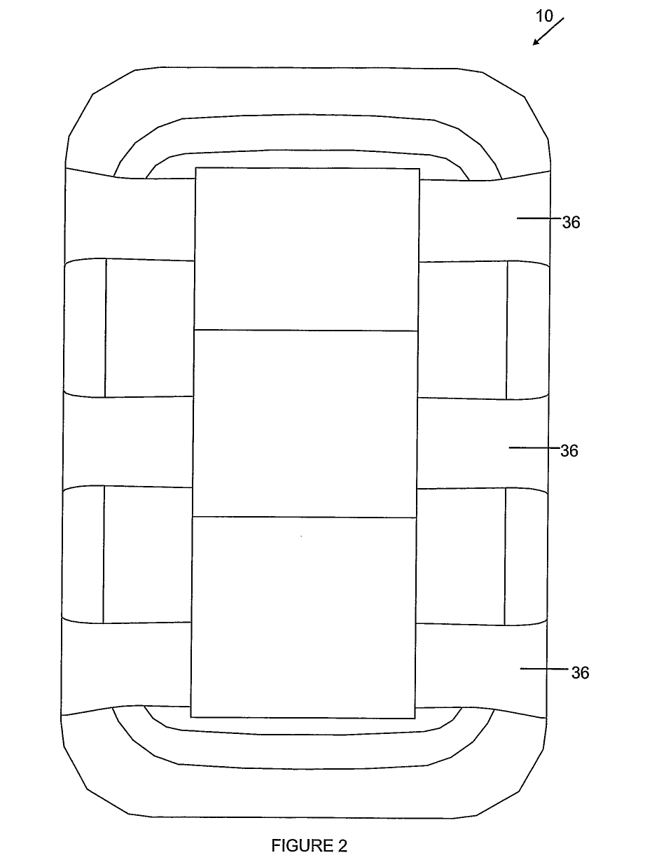

Referring back to FIGS. 2 and 3, it would be noticeable that the terminal edge of each of the mesial edge (14) and the distal edge (16) are rounded or curved edge. In fact, it would be also clear from the same figures that most of the edges in the present invention is either rounded or curved.

The base portion (12) as mentioned earlier is also integrally mounted to the rest of the bracket (10). Reference is now made to FIGS. 3, 4 and 5 wherein there is shown the base portion (12) according to the present invention. The dimension of the said base portion (12) is configured in such a manner that the longitudinal length of the said base portion (12) extends beyond the edges of the gingival and incisal edges (18, 20) of the twin tie wings (22a, 22b). The base portion (12) is further provided with a plurality of cut out section, hereinafter referred as channels (36). Said channels (36) are preferably manufactured by injection molding and its size and width is ensured to be constant throughout its length. Said channels (36) according to the present invention are created during the molding process instead of being milled out to ensure that no stress concentration is created. The internal corners along the channels are rounded. The said channels (36) are designed in such a manner that each channel (36) is tapered at the end approximate to the tooth surface, thus creating the undercuts required for mechanical bonding. Said channels (36) are provided in such a manner that they are positioned parallel in relation to the orientation of the archwire slot (26). In general, said base portion (12) is concave in cross section as shown in FIG. 4.

It should be appreciated that the provision of the configuration and design of the present invention with rounded mesial and distal corners of the archwire slot (42, 44) provided herein to achieve the effect of increased inter-bracket distance as described in the objective of the present invention. Further to this the mesial and distal tie wing undercuts (32, 34) are provided to compensate for the loss of the rotational and angulation control as the result of the rounded slot corners (42, 44). This particular configuration of the mesial and distal tie wing undercuts (32, 34) allows the ligatures or modules to engage farther inwards and this fill up the space created as the result of the rounded slot corners. Further to this, such a configuration is not created separately but molded as part of the design during the injection molding process of the present invention.

Also, it should be appreciated that the design and configuration of the present invention allows the creation of true mechanical undercuts on the base portion (12) with the channels (36) along the edges of the base portion (12). According to the present invention the undercuts channels can be either placed on all four edges (14, 16, 18, 20) of the base portion (12) or on two opposing edges or any other combination possible thereto. The undercut channels extend only a short distance towards the centre of the base portion (12) thus allowing mold separation to occur during manufacturing. Therefore, the body and the base portion as an integral piece can be manufactured to completion in a single process.

While this invention has been described in connection with specific embodiments thereof, it will be understood that it is capable of further modification(s). This application is intended to cover any variations, uses or adaptations of the invention following in general, the principles of the invention and including such departures from the present disclosure as come within known or customary practice within the art to which the invention pertains and as may be applied to the essential features hereinbefore set forth.

As the present invention may be embodied in several forms without departing from the spirit of the essential characteristics of the invention, it should be understood that the above described embodiments are not to limit the present invention unless otherwise specified, but rather should be construed broadly within the spirit and scope of the invention as defined in the appended claims. Various modifications and equivalent arrangements are intended to be included within the spirit and scope of the invention and appended claims. Therefore, the specific embodiments are to be understood to be illustrative of the many ways in which the principles of the present invention may be practiced. In the following claims, means-plus-function clauses are intended to cover structures as performing the defined function and not only structural equivalents, but also equivalent structures. For example, although a nail and a screw may not be structural equivalents in that a nail employs a cylindrical surface to secure wooden parts together, whereas a screw employs a helical surface to secure wooden parts together, in the environment of fastening wooden parts, a nail and a screw are equivalent structures.

“Comprises/comprising” when used in this specification is taken to specify the presence of stated features, integers, steps or components but does not preclude the presence or addition of one or more other features, integers, steps, components or groups thereof.”

1. An improvement to an orthodontic appliance comprising of a bracket (10), which further includes a base portion (12), a body section (24) extending from the base portion (12) characterized in that wherein said improved orthodontic appliance comprises of a plurality of edges (14, 16, 18, 20) and a set of tie wings (22a, 22b), and wherein said orthodontic appliance also includes an archwire slot (26) and wherein a plurality of channels (36) is provided therein on the bottom surface of the orthodontic appliance and wherein a mesial tie wing undercut (32) and a distal tie wing undercut (34) are provided respectively to form a continuous undercut channels with an incisal and a gingival tie wing undercuts (40, 38).

2. An improved orthodontic appliance as claimed in claim 1 wherein the plurality of edges is a mesial edge (14), a distal edge (16), a gingival edge (18) and an incisal edge (20).

3. An improved orthodontic appliance as claimed in claim 1 wherein said edges (14, 16, 18, 20) are integrally mounted to the body section (24).

4. An improved orthodontic appliance as claimed in claim 1 wherein the tie wings are twin tie wings (22a, 22b) and are integrally mounted to the base portion (12) in a manner that it extends outwardly away from the base portion (12).

5. An improved orthodontic appliance as claimed in claim 1 wherein each tie wing (22a, 22b) are positioned parallel and spaced apart from one another.

6. An improved orthodontic appliance as claimed in claim 1 wherein the archwire slot (26) is provided at the body section (24) and wherein said archwire slot (26) is generally extended from the tie wing (22a) and projects to the tie wing (22b).

7. An improved orthodontic appliance as claimed in claim 1 wherein the archwire slot (26) is positioned perpendicular to the mesial and distal edges (14, 16).

8. An improved orthodontic appliance as claimed in claim 1 wherein said archwire slot (26) further includes a mesial end (28) and a distal end (30).

9. An improved orthodontic appliance as claimed in claim 1 wherein said vertical slot (27) is provided at the body section (24) and is positioned extending perpendicular to the archwire slot (26).

10. An improved orthodontic appliance as claimed in claim 1 wherein said vertical slot (27) is a closed channel and is partly hidden in the body section (24).

11. An improved orthodontic appliance as claimed in claim 1 wherein each tie wing (22a) and (22b) further includes a mesial tie wing undercut (32) and a distal tie wing undercut (34) respectively.

12. An improved orthodontic appliance as claimed in claim 1 wherein the gingival edge (18) and the incisal edge (20) further comprises the gingival tie wing undercut (38) and the incisal tie wing undercut (40) respectively.

13. An improved orthodontic appliance as claimed in claim 11 wherein all the undercuts (32, 34, 38, 40) are designed with deep cutting portions and are generally concave in configuration.

14. An improved orthodontic appliance as claimed in claim 11 wherein the mesial tie wing undercut (32) connects the mesial edge (14) to the gingival edge (18) to create a continuous joint.

15. An improved orthodontic appliance as claimed in claim 11 wherein the distal tie wing undercut (34) connects the distal edge (16) and the incisal edge (20) to create a continuous joint.

16. An improved orthodontic appliance as claimed in claim 1 wherein the edges of the mesial and distal (14, 16) are either rounded or curved.

17. An improved orthodontic appliance as claimed in claim 1 wherein the said channels (36) are designed to have a tapered portion at the end approximate to a tooth surface thus creating a required undercut for mechanical bonding.

18. An improved orthodontic appliance as claimed in claim 1 wherein said orthodontic appliance is manufactured to completion as a single integral piece, in a single injection molding process.

19. An improved orthodontic appliance as claimed in claim 1 wherein the archwire slot (26) is provided with rounded or curved mesial and distal corners (42, 44).

20. An improved orthodontic appliance as claimed in claim 12 wherein all the undercuts (32, 34, 38, 40) are designed with deep cutting portions and are generally concave in configuration.
